(19) United States
(12) Patent Application Publication
(10) Pub. No.: US 2023/0347489 A1
(43) Pub. Date: Nov. 2, 2023

(54) PORTABLE TOOL

(71) Applicant: Tim STRAUS, Cleveland Heights, OH (US)

(72) Inventor: Tim STRAUS, Cleveland Heights, OH (US)

(21) Appl. No.: 18/148,169

(22) Filed: Dec. 29, 2022

Related U.S. Application Data
(60) Provisional application No. 63/336,774, filed on Apr. 29, 2022.

(51) Int. Cl. B25F 1/00; B67B 7/40

(52) U.S. Cl. CPC B25F 1/00; B67B 7/403

(57) ABSTRACT

A tool includes a planar body that defines an aperture extending therethrough. The planar body has a first linear edge that partially defines a perimeter of the aperture, and a projection that extends from the first linear edge into the aperture.

### CROSS REFERENCE TO RELATED APPLICATIONS

This application claims priority to, and any other benefit of U.S. Provisional Application No. 63/336,774, filed on Apr. 29, 2022, the entire disclosure of which is incorporated herein by reference as though recited herein in its entirety.

### FIELD OF THE INVENTION

This application generally relates to a portable tool, and more specifically, a portable tool that can be used to manipulate items such as, for example, pull tabs and/or zippers.

### BACKGROUND

Opening a beverage can generally requires pulling a pull tab upward to force open a scored lid on an upper surface of the can. Grasping a pull tab may be challenging for those with very short, very long, and/or manicured fingernails. For instance, reaching to grasp a pull tab may inadvertently cause one or more fingernails to engage the can and become damaged. Some people utilize a conventional bottle opener to open beverage cans in view of these issues. However, such bottle openers are bulky, requiring the user to store the opener in a handbag or in a pocket which may be undesirable for the user.

In a related manner, one may damage their fingernails when attempting to grasp a zipper pull tab (e.g., on a piece of clothing) or when reaching to lift an item from a ground surface, e.g., a credit card dropped on the floor. Therefore, it is desirable to have a portable multi-purpose tool that obviates the foregoing issues.

### SUMMARY OF THE INVENTION

The following presents a simplified summary of the disclosure in order to provide a basic understanding of some example aspects described in the detailed description. This summary is not an extensive overview. Moreover, this summary is not intended to identify critical elements of the disclosure nor delineate the scope of the disclosure. The sole purpose of the summary is to present some concepts in simplified form as a prelude to the more detailed description that is presented later.

In accordance with a first aspect, a tool includes a planar body that defines an aperture extending therethrough. The planar body has a first linear edge that partially defines a perimeter of the aperture, and a projection that extends from the first linear edge into the aperture.

In accordance with a second aspect, a tool includes a planar body including a main portion. The main portion defines an aperture, and a projection extends into the aperture. A curved hook and a tapered hook extend from the main portion. The main portion includes a convex edge facing the curved hook that defines a first slot therebetween. The main portion also includes a first linear edge facing the tapered hook that defines a second slot therebetween.

### BRIEF DESCRIPTION OF THE DRAWINGS

These and other features, aspects and advantages of the present disclosure can be further understood when read with reference to the accompanying drawings:

FIG. 1 is a perspective view of an example tool;

FIG. 2 is a plan view of the tool;

FIG. 3 is a partial, perspective view of the multipurpose tool engaging an example pull tab on a beverage can;

FIG. 4 is a partial section view of the multipurpose tool taken along line 4-4 of FIG. 1;

FIG. 5A is another partial, perspective view of an example hook portion engaging a pull tab on a beverage can;

FIG. 5B is another partial, perspective view of an example hook portion engaging a pull tab on a beverage can;

FIG. 6 is a bottom perspective view of an example pull tab;

FIG. 7 is a perspective view of an example hook portion of the multipurpose tool engaging a zipper pull tab;

FIG. 8 is a perspective view of the example hook portion being slid under an object resting on the ground surface;

FIG. 9 is a plan view of a smartphone with an example sleeve thereon adapted to store the tool;

FIG. 10 is another perspective view of the tool;

FIG. 11 is a front view of the tool;

FIG. 12 is a rear view of the tool;

FIG. 13 is a left side view of the tool;

FIG. 14 is a right side view of the tool;

FIG. 15 is a top view of the tool; and

FIG. 16 is a bottom view of the tool.

### DETAILED DESCRIPTION

Apparatus will now be described more fully hereinafter with reference to the accompanying drawings in which embodiments of the disclosure are shown. Whenever possible, the same reference numerals are used throughout the drawings to refer to the same or like parts. However, this disclosure may be embodied in many different forms and should not be construed as limited to the embodiments set forth herein.

Herein, the terms “substantially,” “about,” and variations thereof are intended to denote that the described features are equal or approximately equal to a value or characteristic, as desired, reflecting tolerances, conversion factors, rounding off, measurement error and the like, and other factors. For example, the term “substantially flat” surface is intended to denote a surface that is flat or approximately flat. As another example, the terms “substantially,” “about,” and variations thereof can denote values or characteristics that are exact or within 10% of exact, for example within 5% of exact, or within 2% of exact.

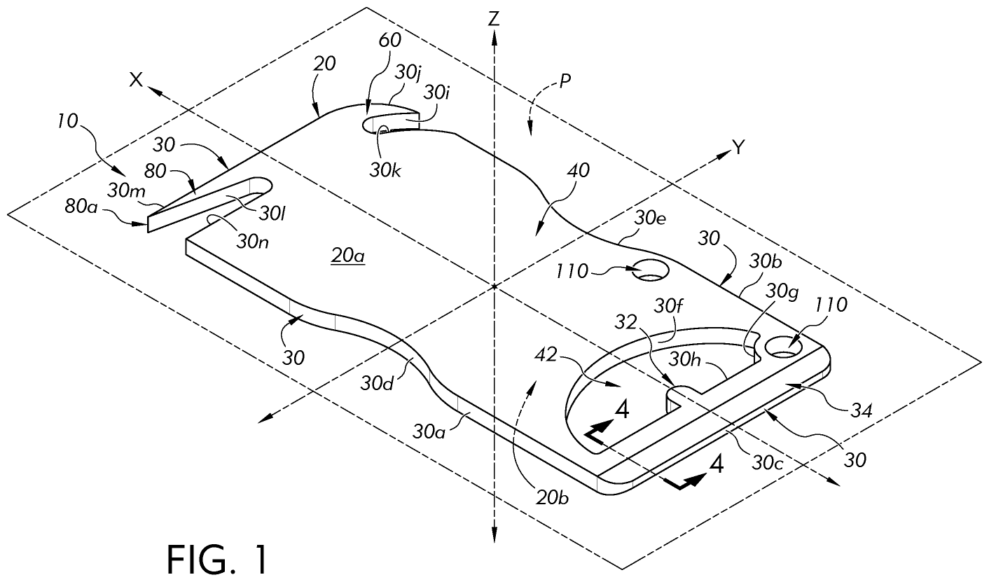

Referring now to FIG. 1, an example multipurpose tool 10 is shown in relation to three orthogonal axes x, y, and z. In general, the tool 10 is an article that a user may conveniently keep on hand (e.g., in a wallet or sleeve) to open canned items (e.g., beverage cans or canned food items), open or close zippers, and/or retrieve items from the ground surface.

The tool 10 comprises a planar body 20 having a unitary structure made of rigid material (e.g., plastic). Preferably, the planar body 20 is dimensioned such that it may fit in a wallet or sleeve without being unwieldy to store, for example, in a pocket, wallet, or purse. For this purpose, the planar body 20 has a thickness (measured in a direction parallel with the z-axis) that preferably is equal to or less than about 0.150″, more preferably equal to or less than about 0.125″, and even more preferably equal to or less than about 0.0625.″ It is contemplated that the planar body 20 may be formed utilizing a variety of manufacturing processes, including, but not limited to, additive manufacturing (e.g., 3D printing), stamp pressing, milling, or any suitable combination thereof. Moreover, the planar body 20 may embody other shapes and sizes, including, but not limited to, a generally round-shaped body, a square-shaped body, or a hexagonal-shaped body.

The planar body 20 has upper and lower surfaces 20a and 20b that are substantially coplanar with a plane P defined by the orthogonal axes x, y. Moreover, the planar body 20 has a plurality of edges 30 extending between and connecting the boundaries of the upper and lower surfaces 20a, 20b. In the illustrated example, most of the edges 30 are “straight” edges, meaning they extend substantially perpendicular to the upper and lower surfaces 20a, 20b. However, it is contemplated that any of the edges 30 may be a rounded edge, a beveled edge, a chamfered edge, or any other combination thereof extending between and connecting the upper and lower surfaces 20a, 20b.

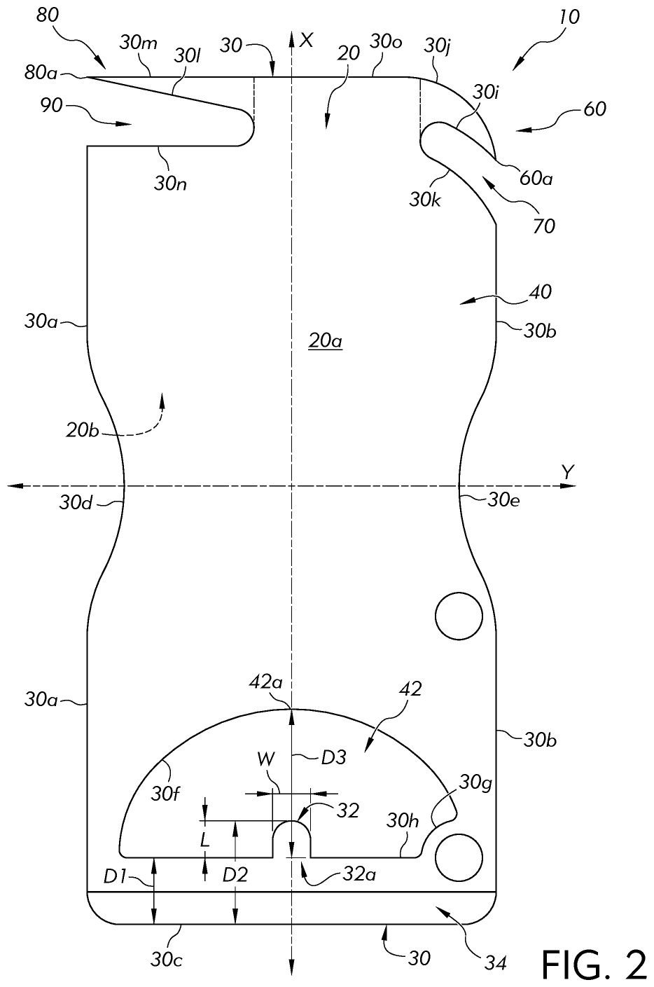

With reference to FIGS. 1 and 2, each edge 30 may extend longitudinally in a linear, convex, or concaved manner. For the purposes of this disclosure, a “linear edge” means an edge that extends longitudinally in a substantially linear direction; a “concave edge” means an edge that extends longitudinally in a concaved manner; and a “convex edge” means an edge that extends longitudinally in convex manner. For example, the planar body 20 in the present embodiment has linear edges 30a, 30b that extend longitudinally in a direction substantially parallel to the x axis, and linear edges 30c, 30h, 30m, 30n, 30o that extend longitudinally in a direction substantially parallel to the y axis. The planar body 20 also has a plurality of convex edges 30g, 30k, 30j and concave edges 30d, 30e, 30f, 30i.

The planar body 20 has a main portion 40 and a plurality of hook portions 60, 80 extending therefrom, which can be used to hook or otherwise manipulate objects as discussed further below. The lines of demarcation between the main portion 40 and hook portions 60, 80 are shown in FIG. 2 using broken lines. The main portion 40 is at least partially defined by left and right linear edges 30a, 30b, a bottom linear edge 30c, an upper linear edge 30o, and left and right concave edges 30d and 30e. In particular, the left and right concave edges 30d and 30e are disposed on opposite sides of the main portion 40 to define a pair of gripping edges. In use, the tool 10 may be held by gripping the upper and lower surfaces 20a, 20b of the planar body 20, for example, with a thumb on one surface and an index finger on the other. Alternatively, the user may grasp various edges 30 extending between the upper and lower surface 20a, 20b (e.g., the concave edges 30d, 30e).

The main portion 40 defines an aperture 42 extending between the upper and lower surfaces 20a, 20b of the planar body 20, and a projection 32 that extends into the aperture 42. The aperture 42 has a perimeter that is defined by a concave edge 30f, a convex edge 30g, and a linear edge 30h that is spaced from and substantially parallel to the bottom edge 30c of the main portion 40. Moreover, the projection 32 extends from the linear edge 30h into the aperture 42, in a direction substantially perpendicular to the linear edge 30h. In some embodiments, the perimeter of the aperture 42 may be defined without the convex edge 30g. It is also contemplated that the perimeter may be defined by other shapes and forms, including but not limited to a generally square or triangular-shaped aperture.

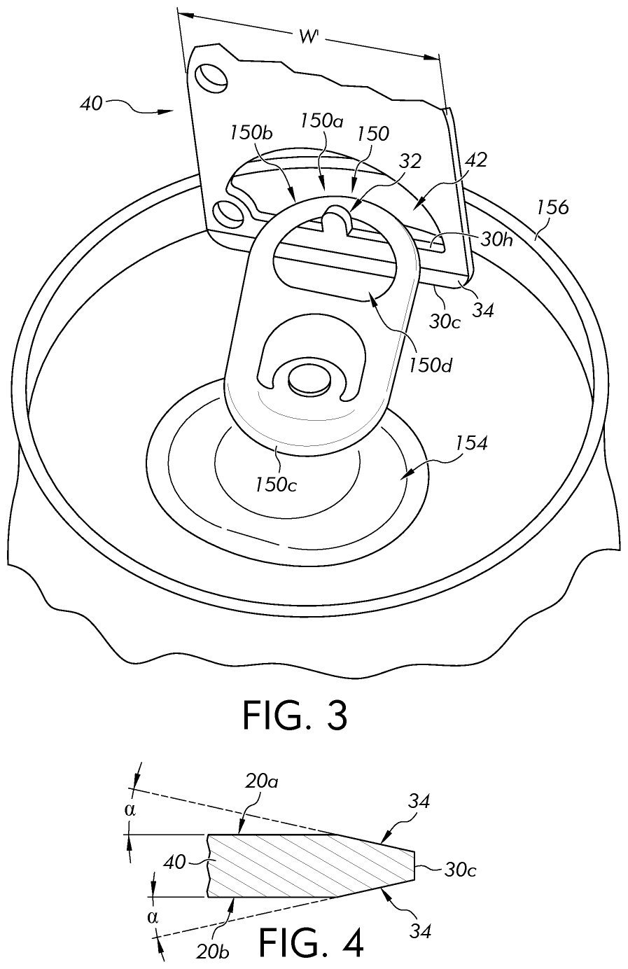

As shown in FIG. 3, the main portion 40 of the tool 10 can be used to open or otherwise manipulate a pull-tab 150 of a beverage can (as shown) or canned food item such as a tuna can, a soup can, a can of vegetables, etc. In particular, the bottom edge 30c of the main portion 40 may be slid under the pull tab 150 until the projection 32 surpasses a ring portion 150b of the pull tab 150. The main portion 40 may then be pivoted and pulled upward (as shown) about the bottom edge 30c, such that the aperture 42 receives the ring portion 150b and the projection 32 extends partially into an opening 150d of the pull tab 150. This action will bring a proximal end 150c of the pull tab 150 into engagement with a scored lid 154 to open the can. Moreover, when the projection 32 is extended through the opening 150d, the ring portion 150b will partially rest against the linear edge 30h such that a distal end 150a thereof latches onto the projection 32. This engagement causes the ring portion 150b to become hooked onto the projection 32, thereby inhibiting the ring portion 150b from disengaging the main portion 40 as the main portion 40 is pulled upward by the user.

The projection 32 and aperture 42 are preferably shaped and dimensioned to cooperate with the pull-tab 150 as described above. For example, the width W (see FIG. 2) of the projection 32 (measured in a direction parallel with the y-axis) is preferably equal to or less than about 0.462″, more preferably equal to or less than about 0.385″, and even more preferably equal to or less than about 0.100″. Moreover, the length L′ of the projection 32 (measured in a direction parallel with the x-axis) is preferably at least about 0.025″, more preferably at least about 0.030″, and even more preferably at least about 0.050″, while a distance D₁ (measured in a direction parallel with the x-axis) between the bottom edge 30c of the planar body 20 and the linear edge 30h of the aperture 42 is preferably at least about 0.080″, and more preferably at least about 0.100″. Furthermore, a distance D₂ (measured in a direction parallel with the x-axis) between the bottom edge 30c of the tool 10 and a tip of the projection 32 is preferably at least about 0.105″, more preferably at least about 0.130″, and even more preferably at least about 0.150.″ Still further, a distance D₃ (measured in a direction parallel with the x-axis) between a base 32a of the projection 32 (coterminous with the linear edge 30h) and an apex 42a of the aperture 42 is preferably at least about 0.250″, more preferably at least about 0.300″, and even more preferably at least about 0.400″. The width W and distance D₃ as dimensioned can enable the pull tab 150 to fit through the aperture 42, while the Length L′ and distances D₁, D₂ as dimensioned can enable the main portion 40 to be slid under the pull tab 150 and then be pivoted and pulled upward (as shown) such that the ring portion 150b becomes securely hooked onto the projection 32.

With reference to FIG. 4, the bottom edge 30c of the main portion 40 may be a beveled edge having one or more tapered portions 34 to further facilitate guiding the main portion 40 under the pull tab 150 as described above. In such embodiments, each tapered portion 34 is preferably inclined at an angle α between about 6 degrees and 30 degrees, and more preferably about 22 degrees relative to the upper and lower surfaces 20a, 20b of the planar body 20, respectively.

In addition, the main portion 40 is preferably shaped and dimensioned so that it may be slid underneath the pull tab 150 without engaging a circumferential lip or rim 156 disposed on the can. For this purpose, the width W′ (measured in a direction parallel with the y-axis) of the main portion 40 is preferably equal to or less than about 1.70″, more preferably equal to or less than about 1.50″, and even more preferably equal to or less than about 1.10″.

Turning back to FIGS. 1 and 2, the hook portion 60 comprises alternative structure for engaging the pull tab 150. In particular, the hook portion 60 has a concave edge 30i and a convex edge 30j each extending from the main portion 40 and converging at a tip 60a of the first hook portion 60. Moreover, the main portion 40 has a convex edge 30k facing the first hook portion 60 and defining a slot 70 therebetween. Specifically, the convex edge 30k extends to and intersects with the right linear edge 30b of the main portion 40. In use, the hook portion 60 can be slid under the ring portion 150b of the pull tab 150 and then guided through the opening 150d to thereby hook the ring portion 150b. The first hook portion 60 can then be pulled upward (with the hooked ring portion 150b) to open the can.

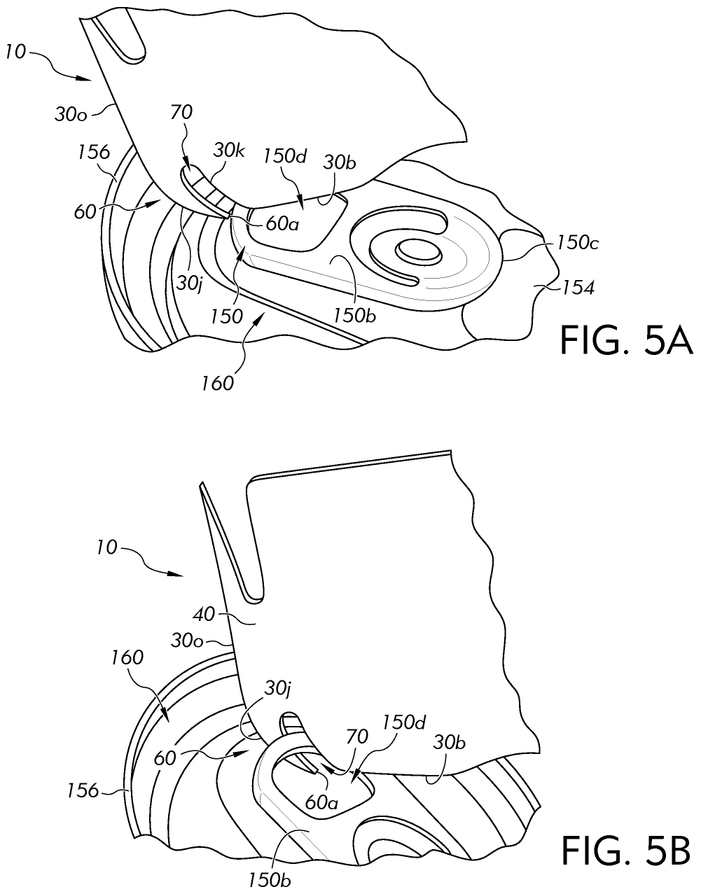

Moreover, the edges 30 of the main portion 40 and hook portion 60 can facilitate the above action by guiding the tip 60a of the first hook portion 60 under the ring portion 150b and then through the opening 150d. For example, as shown in FIG. 5A, the tool 10 can be initially arranged such that the convex edge 30k of the main portion 40 is in contact with the ring portion 150b of the pull tab 150, and the top edge 30o of the main portion 40 and the convex edge 30j of the hook portion 60 are respectively in contact with the rim 156 and upper surface 160 of the can. That is, the top edge 30o and the convex edges 30j, 30k are self-locating features to bring about the initial engagement between the tool 10 and can. The tool 10 can then be pivoted while the top edge 30o and the convex edges 30j, 30k remain in contact with and slide along their respective contact points with the can until the tip 60a of the hook portion 60 is inserted under the ring portion 150b and through the opening 150d, thereby assuming the configuration shown in FIG. 5B. Such sliding engagement of the top edge 30o and the convex edges 30j, 30k along the rim 156, upper surface 160, and ring portion 150b, respectively, will space and guide the tip 60a in an appropriate motion such that it slides properly under the ring portion 150b.

Once the tool 10 assumes the configuration in FIG. 5B, the user can then pivot the tool 10 about the contact point between its top edge 30o and the rim 156. Such pivoting will cause the hook portion 60 to lift the ring portion 150b of the pull tab 150 upwards such that the proximal end 150c of the pull tab 150 pushes downward on the scored lid 154 to open the can.

In some examples, prior to arranging the tool 10 as shown in FIG. 5A, the tool 10 can be arranged such that the right linear edge 30b of the main portion 40 is in contact with the ring portion 150b (instead of the convex edge 30k). In such embodiments, the right linear edge 30b of the tool 10 can then be slid along the ring portion 150b until the tool 10 assumes the configuration shown in FIG. 5A. The tool 10 can then be manipulated as described above to assume the configuration in FIG. 5B and then open the can.

The slot 70 between the main portion 40 and hook portion 60 preferably is wide enough to receive the ring portion 150b of the pull tab 150 therethrough during the opening motions described above. For this purpose, the width of the slot 70 (measured in a direction normal to the convex edge 30k) is preferably at least about 0.500″, more preferably at least about 0.600″, and even more preferably at least about 0.900″. The width of the slot 70 in the present example is about 0.935″.

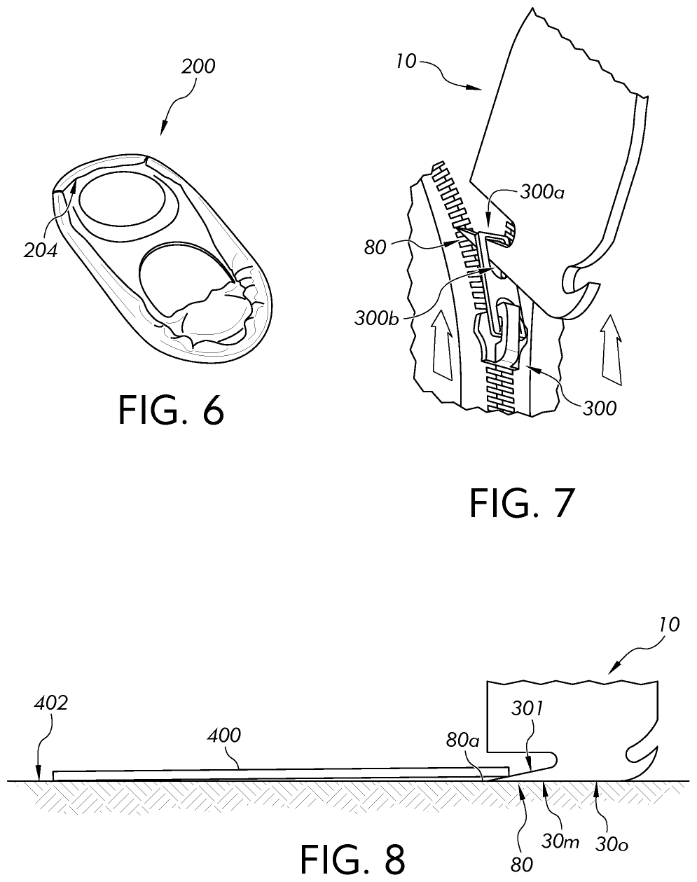

Referring to FIG. 6, the hook portion 60 may also be useful to open pull tabs 200 that do not have an opening but have an edge 204, rib, or other structure that the tip 60a of the hook portion 60 can engage to grasp the pull tab 200. In this manner, the hook portion 60 is versatile such that it may be used to grasp a variety of pull tabs.

As noted above, the tool 10 further includes a second hook portion 80 (see FIGS. 1 and 2) extending from the main portion 40. The hook portion 80 embodies structure that enables the tool 10 to open or close zippers or retrieve items from a ground surface. Specifically, the hook portion 80 is a tapered hook having a width that gradually decreases from the main portion 40 to a tip 80a thereof. The hook portion 80 includes a first linear edge 301 and a second linear edge 30m, which extend from the main portion 40 (at an acute angle relative to each other) and converge at the tip 80a. Preferably, the angle between the first and second linear edges 301 and 30m is between about 4 and 35 degrees, more preferably between about 6 degrees and 30 degrees, and even more preferably about 12 degrees. In addition, the main portion 40 has a third linear edge 30n facing the first linear edge 301 and defining a slot 90 therebetween.

As shown in FIG. 7, the hook portion 80 can be used to open or close zippers 300 with pull tab openings 300b by inserting the hook portion 80 through the opening 300b and pulling the tool 10 to manipulate the zipper 300. Moreover, the tapered configuration (as defined by the angle between first and second linear edges 301 and 30m) enables the hook portion 80 to be inserted through openings 300b of various sizes while still having sufficient rigidity (as compared to thinner hook portions that have a constant, narrow width).

Referring to FIG. 8, the hook portion 80 serves another useful function of retrieving or lifting a thin object 400 (e.g., a credit card) resting on a flat surface 402. In use, a user may apply downward pressure on the object 400 while arranging the tool 10 such that the linear edges 30m, 30o of the second hook portion 80 and the main portion 40 rest on the surface 402 with the tip 80a of the second hook portion 80 facing the object 400. The linear edges 30m, 30o can then be slid along the surface 402 toward the object 400 until the hook portion 80 engages the object 400. Further sliding movement will cause the tip 80a and linear edge 301 of the hook portion 80 to slide under the object 400 such that the object 400 is lifted from the surface 402 and can be easily grabbed by the user.

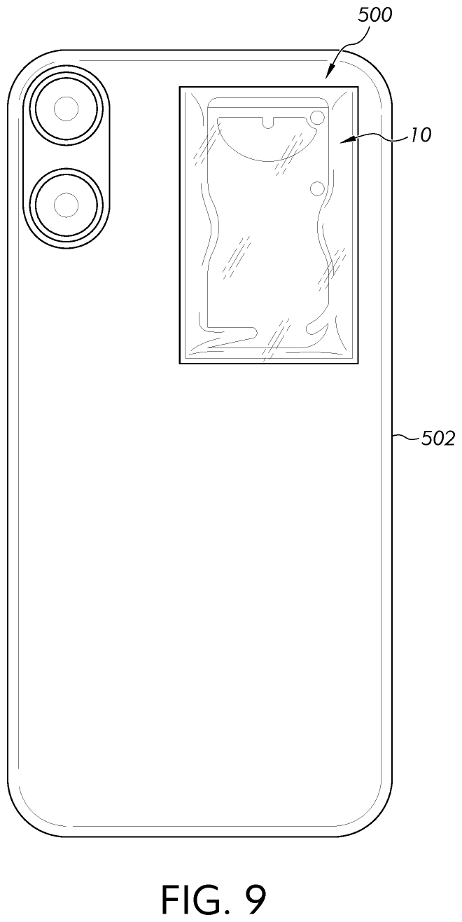

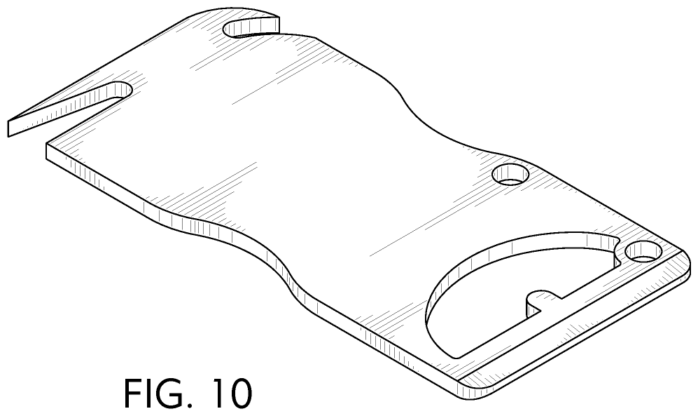

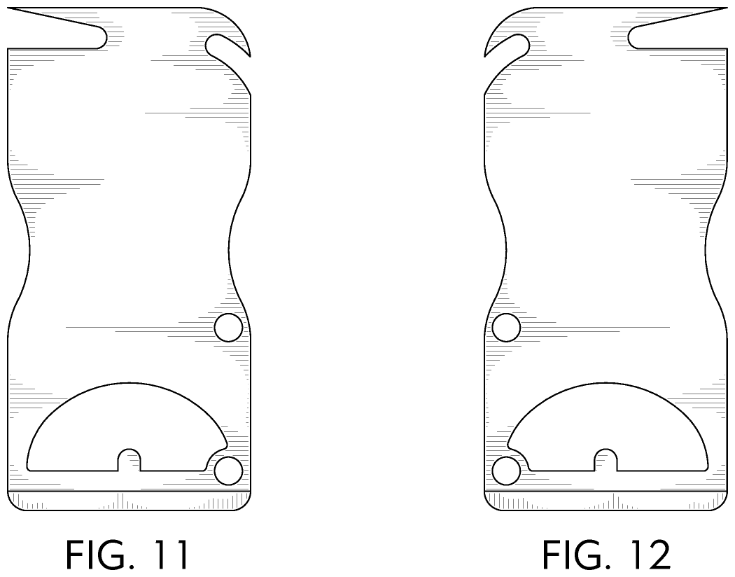

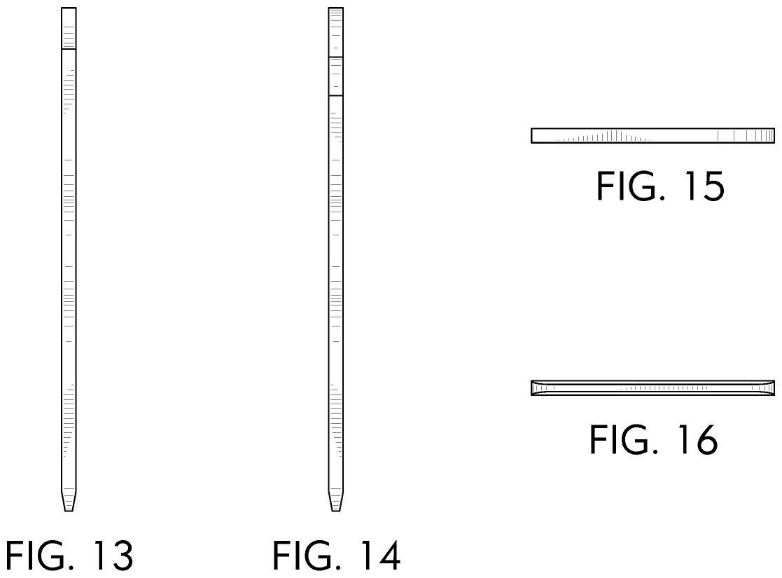

As shown in FIG. 9, the tool 10 in some examples can be distributed and/or sold as a kit with a sleeve 500 defining a pocket that is shaped and dimensioned to receive the tool 10 therein. Moreover, the sleeve 500 may comprise an adhesive thereon for affixing the sleeve 100 (and thus the multipurpose tool 10) to a personal device 502 (e.g., a mobile phone).

In other embodiments, the planar body 20 of the tool 10 may define one or more apertures 110 (see FIG. 1) extending therethrough that are shaped and dimensioned to receive a key ring from a key chain for supporting the tool 10 therefrom.

The tool 10 as described above can thus be utilized to manipulate various objects such as pull tabs, zippers, credit cards, tec. Moreover, the tool 10 can be particularly useful for users with long and/or freshly manicured nails, as it can be used to manipulate objects while preventing the user's nails from engaging the objects and possibly being damaged. However, it is to be appreciated that the tool 10 can have various modifications without departing from the scope of the disclosure. For instance, the tool 10 in some embodiments may comprise the main portion 40 without one or both of the hook portions 60, 80. As another example, the hook portions 60, 80 can be arranged at other positions relative to each other and/or the main portion 40.

While the various inventions disclosed herein have been described with reference to the example embodiments described above, it should be understood that modifications and alterations will occur to others upon a reading and understanding of this specification without departing from the spirit and scope of the invention set forth in the appended claims. Example embodiments incorporating one or more aspects of the invention are intended to include all such modifications and alterations insofar as they come within the scope of the appended claims and their equivalents. In this manner, it is contemplated that aspects of one embodiment may be combined with another.

Moreover, it should be understood that the order of discussion is not limiting and is only provided for ease of describing the various examples of a tool disclosed herein. Similarly, the positions (e.g., upper, lower, left, right, bottom) described herein are provided for ease of disclosing the illustrated embodiments. In this manner, it should be appreciated that positions may be different in other embodiments without departing from the scope of the present disclosure.

1. A tool comprising a planar body that defines an aperture extending therethrough, the planar body having a first linear edge that partially defines a perimeter of the aperture, and a projection that extends from the first linear edge into the aperture.

2. The tool according to claim 1, wherein the planar body includes a main portion that defines the aperture, and a hook portion extending from the main portion.

3. The tool according to claim 2, wherein the hook portion is tapered.

4. The tool according to claim 3, wherein the hook portion includes a first linear hook edge and a second linear hook edge extending from the main portion to a tip of the hook portion, wherein the first linear hook edge extends at an acute angle relative to the second linear hook edge.

5. The tool according to claim 2, wherein the hook portion is curved.

6. The tool according to claim 5, wherein the hook portion includes a convex edge extending from the main portion to a tip of the hook portion, said convex edge being configured to slidably engage a portion of a can to guide a tip of the hook portion under a pull tab of a can and then through an opening in the pull tab.

7. The tool according to claim 2, wherein the main portion includes a convex edge that faces the hook portion, the convex edge and the hook portion defining a slot therebetween.

8. The tool according to claim 7, wherein the planar body includes a second linear edge that intersects with the convex edge, wherein the second linear edge and the convex edge are configured to slidably engage with and guide a pull tab into the slot.

9. The tool according to claim 2, wherein the main portion includes a pair of concave edges disposed on opposite sides of the main portion to define a pair of gripping edges.

10. The tool according to claim 2, wherein the main portion includes a beveled edge spaced from and substantially parallel to the first linear edge.

11. The tool according to claim 1, wherein the planar body includes:
a main portion that defines the aperture and the projection,
a first hook portion extending from the main portion, the first hook portion being tapered, and
a second hook portion extending from the main portion, the second hook portion being curved.

12. The tool according to claim 1, wherein the main portion defines a second linear edge that is spaced from and parallel to the first linear edge, wherein a distance between the first linear edge and the second linear edge is at least about 0.080″.

13. A kit comprising:
the tool according to claim 1; and
a sleeve defining a pocket configured to accommodate the tool therein.

14. The kit according to claim 13, wherein the sleeve comprises an adhesive thereon adapted to removably secure the sleeve to another object.

15. A tool including a planar body, the planar body comprising:
a main portion defining an aperture and a projection that extends into the aperture,
a curved hook extending from the main portion, and
a tapered hook extending from the main portion,
wherein the main portion includes a convex edge facing the curved hook and defining a first slot therebetween, and
wherein the main portion includes a first linear edge facing the tapered hook and defining a second slot therebetween.

16. The tool according to claim 15, wherein the main portion includes a second linear edge that partially defines a perimeter of the aperture, and a beveled edge spaced from and substantially parallel to the second linear edge.

17. The tool according to claim 15, wherein the main portion includes a pair of concave edges disposed on opposite sides of the main portion to define a pair of gripping edges.

18. The tool according to claim 15, wherein the main portion includes a second linear edge that intersects with the convex edge, wherein the second linear edge and the convex edge are configured to slidably engage with and guide a pull tab into the slot.

19. The tool according to claim 15, wherein the tapered hook includes a first linear hook edge and a second linear hook edge extending from the main portion to a tip of the tapered hook, wherein the first linear hook edge extends at an acute angle relative to the second linear hook edge.

20. The tool according to claim 15, wherein the curved hook includes a convex edge extending from the main portion to a tip of the curved hook, said convex edge being configured to slidably engage a portion of a can to guide a tip of the hook portion under a pull tab of the can and then through an opening in the pull tab.
